(19) United States
(12) Patent Application Publication
(10) Pub. No.: US 2023/0177971 A1
(43) Pub. Date: Jun. 8, 2023

(54) Systems and Methods For Cognitively Enhanced Repetitive Combinatorial Learning Activities For Mathematics

(71) Applicant: Matthew T. Mowery, Irvine, CA (US)

(72) Inventor: Matthew T. Mowery, Irvine, CA (US)

(21) Appl. No.: 18/076,271

(22) Filed: Dec. 6, 2022

Related U.S. Application Data
(60) Provisional application No. 63/286,916, filed on Dec. 7, 2021.

(51) Int. Cl. G09B 7/02; G09B 23/02; G06Q 50/20

(52) U.S. Cl. CPC G09B 7/02; G09B 23/02; G06Q 50/2057

(57) ABSTRACT

A system and method for augmenting cognitive retention of mathematical skills via the use of combinatorial and repetitive competitive activities. More specifically, such combinatorial and repetitive competitive activities comprising the use of a set of objects having one or more associated numerical values for each object. The objects distributed in rounds to students. The students attempting to develop a mathematical expression that solves for a solution value by combining the numerical objects with mathematical operators.

### CROSS-REFERENCE TO RELATED APPLICATIONS: This

application claims the benefit of U.S. Provisional Patent Application No. 63/286,916 filed on Dec. 7, 2021.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD

The inventive subject matter described herein is related to systems and methods for the development of learning skills and maintenance of cognitive reasoning in children and adults via specialized object-centric activities. More particularly, the inventive subject matter is directed to systems and methods to cognitively enhance and augment a student learner's mathematical skills via repetitive and combinatorial learning. Still further, the system and method are directed to systems and methods to help all individuals maintain and diminish the loss of mental acuity.

### BACKGROUND

We live in an extremely fast-paced world where interactions can be transient and are likely designed to be intentionally immediately rewarding. For example, children and adults enjoy playing video games due to the animation, action, and rapid feedback and rewards. Irrespective of whether video games are positive or negative for children, it is demonstrated that video games are appealing to a large demographics. Successful video games tend to proceed at such a rapid clip that the experience tends to be transitory and quickly forgotten by a student. Consequently, the ability of a child to retain specific techniques that were experienced during the game may be lessened or limited to very narrow techniques without significant repetition across months of use. The ability to conveniently participate in exciting multi-student or single-student video games on one's computer without having to leave one's room is a recognized daily activity for many kids in today's society, particularly in light of the multiplicity of societal changes due to the Covid19 pandemic. Unfortunately, the swiftness and transitory elements associated with aspects of these gaining instances are known to negatively impact at least long-term cognitive retention.

It is generally accepted by today's neurologic experts that when we learn something, even as simple as someone's name, we form connections, called synapses, between neurons in the brain. These synapses create new circuits between nerve cells, essentially remapping the brain. The sheer number of possible connections gives the brain unfathomable flexibility wherein each of the brain's one hundred billion nerve cells can have 10,000 connections to other nerve cells. Those synapses get stronger or weaker depending on how often an individual may be exposed to an event, i.e., repetition. The more an individual is exposed to an activity, like a golfer practicing a swing thousands of times, or a musician playing a score hundreds of times, typically, the stronger the connections. The less exposure, typically, the weaker the connection. The type of exposure, and how that exposure engages one or more sensory modalities is also critical to supporting long-term cognitive development and information retention. A straightforward example is an activity of trying to remember a person's name after a first Introduction.

Creating a memory requires an individual to encode information associated with an event. For example, there can be a correlation between when you notice an event or come across a piece of information where a person's brain consciously perceives the sounds, images, physical feelings, smells, or other sensory details involved with that event. Attaching meaning or factual knowledge to this sensory input comprises semantic coding, which allows one to remember things and retain them longer. Unfortunately, the ephemeral aspect of today's digital transactions/interactions is sufficiently transient and fleeting that a person is less likely to remember various details. For example, as a person moves to a new email message from an earlier message, it is typically difficult for the person to remember the previous message, and very difficult to remember messages reviewed just a few moments ago.

Various methods have been developed to enhance memory, e.g., using mnemonics, creating a memory palace, chunking content, and associating images. These methods are slower-paced and not attractive to children used to video gaining. For older adults, they can be too complex or boring to ensure engagement. Hence, there exists a need to develop an approach that serves as a teaching and learning tool that can be perceived as interesting and even exciting to readily allow a student to participate in a manner that will reinforce retention of the elements of the activity or transaction.

The problem of momentary retention of an episode or event would benefit from systems and methods that enhance cognitive retention of the episode or event, including its associated details. In addition, cognitive decline and mental impairment are major concerns for the aging population. Hence, the ability to introduce new systems and methods to minimize cognitive decline would translate into improved quality of life and lower costs associated with healthcare for the elderly.

Further, supporting the enhancement of cognitive retention and knowledge-building skills and techniques would benefit from a teaching solution deployed as a competition, test, or activity that enhances the ability of a student to retain memories of the events and episodes associated with the activity, while also keeping the student engaged at an enticing or interesting level.

### SUMMARY

In view of the foregoing described needs, an aspect of the inventive subject matter is directed to systems and methods to enhance and augment cognitive retention of an individual learner's mathematical skills via the use of specialized virtual, digital, physical, and tangible objects and collateral components. In particular, the methods associated with the inventive subject matter comprise learning systems including a repetitive, combinatorial approach through the use of various types of manipulative objects, cards, and collateral components to improve a student's mathematical skills. Cards may be configured having relevant mathematical information designed to support various learning levels and ages of participants. During an activity, for instance, four unique cards may be delivered and displayed to one or more students, or the students may simply draw four cards from an available repository. Each student then attempts to create an arrangement of the selected cards, in combination with mathematical operators, to develop a mathematical expression that may be solved to arrive at a predefined solution value. For example, the activity could be directed to solving for a desired numerical solution value of “21”. Mathematical principles and mathematical operators are applied by the student(s) participating in an activity to the values associated with each of the objects. The process of considering different sets of possible numerical combinations in conjunction with one or more mathematical operators causes the student(s) to develop and retain the mathematical know-how for future cognitive access. In essence, the student is developing a set of tactics based on the objects provided to arrive at a particular objective which, based on the repetitive and combinatorial approach associated with the method, will evolve to allow the student to develop both strategic and tactical approaches to solving mathematical problems.

In an activity, a student may compete against time, against other students, or both. The complexity and objective of each activity may be adapted as the skill of a student improves. In addition, students may be challenged by the inclusion of a “wild card” wherein the value of the wild card may be varied. Rather than simply learning discrete pieces of information, students are also learning conceptual understanding, number fluency, and computational mathematics. Further, the system and method associated with the activity motivate the students to participate in the activity rather than merely sit back and watch other students solve the problems.

The system and method lend themselves to group collaboration by allowing two or more students to work on each activity cooperatively. Ultimately, the system and method touch on key elements of computational mathematical proficiency including conceptual understanding, number fluency, strategic competence, adaptive reasoning, and productive disposition. Cognitive scientists have concluded that competence in an area of inquiry depends upon the knowledge that is not merely stored but represented mentally and organized (connected and structured) in ways that facilitate retrieval and application. Thus, learning with understanding is more powerful than simply memorizing because the organization improves retention, promotes fluency, and facilitates learning-related material. The system and method of the inventive subject matter accomplish these objectives.

In one embodiment, the system and method are described as comprising an activity, hereinafter referred to by the inventor as “GOKIRO™” GOKIRO™ involves presenting four cards displaying any of the numbers between one and ten where participating students race to build computational mathematical expressions involving the values on the four cards in combination with the application of one or more mathematical operators to arrive at a desired numerical value, e.g., “21”.

For clarification, a mathematical expression is defined herein as a finite combination of numerical values and mathematical symbols that are arranged according to rules that depend on the context of a specific activity. Mathematical symbols designate numbers, operations, brackets, punctuation, and grouping to help determine the order of operations, and other aspects of logical syntax. Specific mathematical symbols include digits (1 through 10), parentheses, arithmetic add, subtract, multiply, divide, powers (x^{Y}), roots, and factorials.

Elementary arithmetic, establishing one aspect of an activity level, is defined herein as the simplified portion of mathematics that includes the operations of addition, subtraction, multiplication, and division. Elementary arithmetic starts with the natural numbers and the written symbols (digits) that represent them. The typical process for combining a pair of these numbers with the four basic operations traditionally relies on memorized results for small values of numbers, including the contents of a multiplication table to assist with multiplication and division.

A further aspect of the inventive subject matter comprises an input management and tracking system. The input management and tracking system support the acquisition of data concerning a student's performance to identify areas for improvement and an appropriate learning or curriculum roadmap. The system and method incorporate features and functionality associated with one or more object or card-based activities, as defined by associated rule sets. In one instance, the system and method comprise an activity where objects may be arranged by a student to form a mathematical combination that will equal a predetermined numerical value, i.e., a solution value, such as “21”

The inventive subject matter described herein further provides digital solutions, both mobile and web-based, for augmenting cognitive retention of mathematical principles. The system comprises the integration of a software application comprising one or more software modules deployable on a desktop, laptop, tablet, smartphone, or other mobile device wherein the system facilitates the delivery of one or more activities configured to support the augmentation of cognitive retention of math skills. The software application may be deployed as an independent software application or in conjunction and integration with one or more other software applications, including social media applications.

The system interrogates and extracts information from one or more data sources to populate a student profile. The system may aggregate data to create a centralized and personalized dashboard resource for a teacher or student to facilitate the intelligent delivery of appropriate activities. This student-centric functionality is used by the system to intelligently adapt its operation and orchestration of other elements to the specific needs of each student. For example, as a student engages in an activity, the system causes the student's performance data to be collected and aggregated to enhance the system's assessment of recommended next learning steps, i.e., curriculum, and, to provide reports for instructors to include subjective recommendations for changes to the student's next learning steps.

The inventive subject matter, in one embodiment, comprises a mobile and Internet-deployable system and method to support enhanced delivery of activities to augment cognitive retention of mathematical skills that can be translated to use in a standard school learning environment.

In one aspect, the system and method promote long-term cognitive retention of mathematical skills by presenting one or more digital and sensory activities to a student requiring the student to generate a plurality of responses that will strengthen a student's memory trace associated with the performance of the activities. Each activity is configured to cause the student to engage with multiple retrieval cues to enhance subsequent availability in the student's memory after the completion of the activity. Additionally, an activity may be configured to trigger one or more memorable milestones during various phases of completion of the activity wherein the milestones reinforce the understanding of mathematical skills.

In both a digital and non-digital implementation, the system and method can provide rewards for accomplishing various milestones and incorporate scoring that lends to the competitive element of the activity, creating a gaining aspect for incentivization.

The system intelligently provides recommendations for new activities to be presented to a target student according to a predefined mathematical curriculum or trigger points associated with the student's performance. Each new activity or activity level can be adapted to the interests, age, sex, and other demographic features of a student.

In another aspect, the system provides a collaborative opportunity for a first student, having completed an activity, to select an activity for delivery to one or more other students. In an additional aspect, the system and method provide intelligent recommendations for the association of certain activity levels or types of activities with a student's current profile. A student's profile may be supplemented via input from a teacher and parent based on their subjective and objective assessments of a student's capabilities, and, including input and feedback from the student. The system applies one or more quantitative and qualitative algorithms to process the aggregate information to determine the optimal presentation of activities to a student.

### BRIEF DESCRIPTION OF THE DRAWINGS

For a better understanding of the inventive subject matter, reference is made to the detailed description contained herein and the accompanying drawings numbered below which are given by way of illustration only and are not intended to be limiting to any extent. Commonly used reference numbers identify the same or equivalent parts of the claimed invention throughout the several figures. These and other features, aspects, and advantages of various embodiments of the inventive subject matter will become better understood with regard to the following description, appended claims, and accompanying drawings where:

FIG. 1 is a block diagram illustrating components associated with an activity according to the inventive subject matter;

FIG. 2 is a flowchart of the steps associated with a method of an activity according to the inventive subject matter;

FIG. 3 is an illustration of a first exemplary set of card objects dealt during a round with a first associated mathematical expression;

FIG. 4 is an illustration of the first exemplary set of card objects dealt during a round with a different second associated mathematical expression;

FIG. 5 is an illustration of a second exemplary set of card objects dealt during a round with an associated mathematical expression;

FIG. 6 is an illustration of another exemplary set of card objects dealt during a round wherein the card objects have mathematical options on the face of each card to support the development of applicable mathematical expressions, according to the inventive subject matter;

FIG. 7 is a block diagram of exemplary elements of a software implementation of an activity, according to the inventive subject matter;

FIG. 8 is a flowchart of the steps associated with competing in an activity via a software application, according to the inventive subject matter;

FIG. 9 is a diagram of activity participation by multiple student/learners illustrating positive emotional results from the activity, according to the inventive subject matter;

FIG. 10 is a simplified view of the cognitive process associated with features inherent to the activity, according to the inventive subject matter;

FIG. 11 is a timeline and interaction diagram comparing standard mathematical learning processes with the learning process associated with an activity, according to the inventive subject matter;

FIG. 12 is an illustration of an exemplary communication network for deployment and use of the systems and methods, according to the inventive subject matter;

FIG. 13 is a block diagram of the elements of a typical compute node used to play an activity, according to the inventive subject matter; and,

FIG. 14 is an illustration of an alternative embodiment of a version of an activity, according to the inventive subject matter.

### OBJECTS

One object of the inventive subject matter is directed to causing a student to achieve cognitively enhanced remembrance of mathematical skills, including arithmetic and algebraic.

Another object of the inventive subject matter described herein is to provide an object-based activity that can be used by the elderly to improve cognitive performance and memory retention.

A further object of the inventive subject matter described herein is to provide activities that can be used in an enjoyable and challenging manner to help refresh, maintain, and enhance an individual's mathematical skills.

Furthermore, another object of the inventive subject matter is to provide a system and method that can be scaled for use across many learning environments, both in school and at home, and scale to accommodate different student populations.

### DETAILED DESCRIPTION

The following description is exemplary and is in no way intended to limit the invention, the inventive subject matter, its application, or its uses. Before the inventive subject matter is described in further detail, it is to be understood that the invention is not limited to particular aspects described, as such may, of course, vary. It is also to be understood that the terminology used herein is for describing particular aspects only and is not intended to be limiting since the scope of the present invention will be limited only by the appended claims. In particular, the system and method for presenting one or more mathematical activities to one or more students may be described in the context of digital interactions, but the system and method are equally applicable to creating enhanced cognitive retention of hybrid transactions which may comprise both digital and tangible items of any type, in any category, subject matter, domain, classification, physical configuration, and tactical properties (e.g., Braille).

Unless defined otherwise, all technical and scientific terms used herein have the same meaning as commonly understood by one of ordinary skill in the art to which this inventive subject matter belongs. Although any methods and materials similar or equivalent to those described herein can also be used in the practice or testing of the inventive subject matter, a limited number of the exemplary methods and materials are described herein.

It must be noted that as used herein and in the appended claims, the singular forms “a”, “an”, and “the” include plural referents unless the context dictates otherwise.

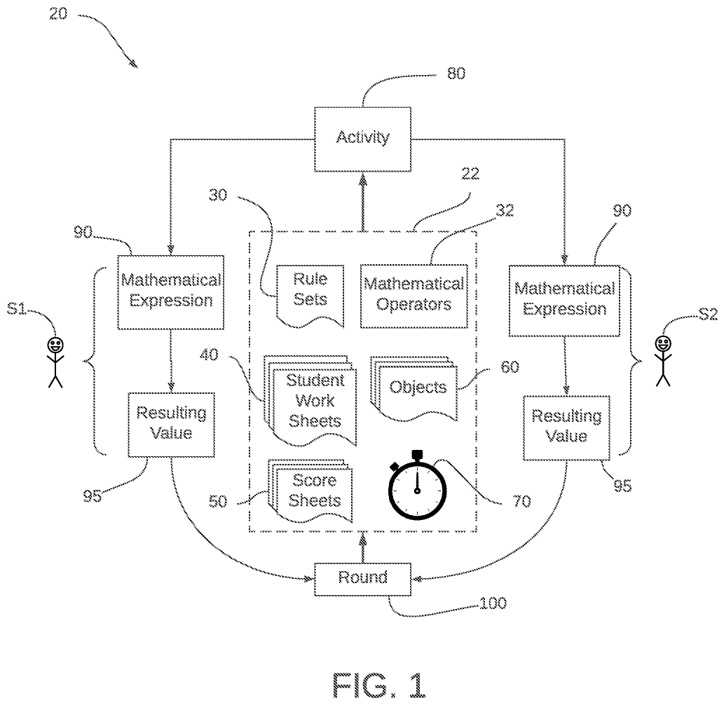

As used herein, a student may be represented by the reference letter, S, Sl, or S2, consistent with the context in which it is used. When describing the competition between just two students as illustrated in FIG. 1, Sl and S2 are used to illustrate that the first student Sl is competing independently against the other student S2 to win a round. Generically, all students may be referred to as S. The present disclosure is not limited only to students but is likewise applicable to others having needs to further develop, refresh or simply maintain certain levels of mathematical cognitive abilities. Hence, a student can be considered any individual, including the elderly, where the individual is not necessarily enrolled in a school.

Referring now to FIG. 1, a system 20 supports the enhancement of mathematical skills according to the inventive subject matter for one or more participating students, hereinafter, student S, to create mathematical expressions 90 using the numerical value associated with provided objects 60 in combination with mathematical operators 32 to arrive at a previously selected solution value 95 via the computation of the mathematical expression 90. In one version, the selected numerical solution value 95 may be twenty-one (“21”).

In a first embodiment, system 20 supports participation by at least two students Sl, S2 in activity 80 using various elements 22. Elements 22 supported by system 20, in one instance, comprise objects 60 comprising cards numbered I through 10 and other specialized cards suited to the level of each participant. An activity is engaged according to one or more rule sets 30. In non-digital versions, a plurality of student worksheets 40, and one or more score sheets 50 are provided. Where activity 80, comprising a competitive aspect, includes a timed component, a timer 70 is likewise included. Rule sets 30 describe the guidelines to be adhered to during activity 80. The student worksheet 40 is used by each of the students S to write down one or more potential mathematical expressions 90 based on the distributed objects 60 to arrive at an expression 90 that will produce the selected target numerical value 95. Alternatively, rather than writing down the mathematical expression, an activity may allow each student to verbally state the solution. Each score sheet 50 is used to track the rounds 100 won by each student S. The timer 70 may be used to set a time limit to arrive at a proposed mathematical expression 90 for each round 100 of play for the students Sl, S2.

The system 20, in one instance, prescribes a rule set 30 for an activity 80 that requires the use of natural or whole numbers combined with a limited set of mathematical operators, wherein mathematical expressions 90 can be more easily created by a student S without the use of additional compute resources, such as a calculator, tablet, or cell phone. In this instance, fractions are not used.

Rule sets 30 and object collections 60 may be modified to suit the level of skill of the students S involved. As student S capability evolves and improves through the course of activity 80, the rules 30 of activity 80 may be modified to create a more interesting activity 80 for student S. For example, at a higher level of mathematical competence, fractions may be used in the activity 80 to generate a mathematical expression 90 to arrive at a targeted solution value 95. An activity 80 may be played with a plurality of different types of objects 60. If more than four students S are simultaneously engaged in an activity, it is preferable to use at least one hundred objects 60. Thus, activity 80 is scalable to accommodate a plurality of students S simply by combining two or more sets of objects 60.

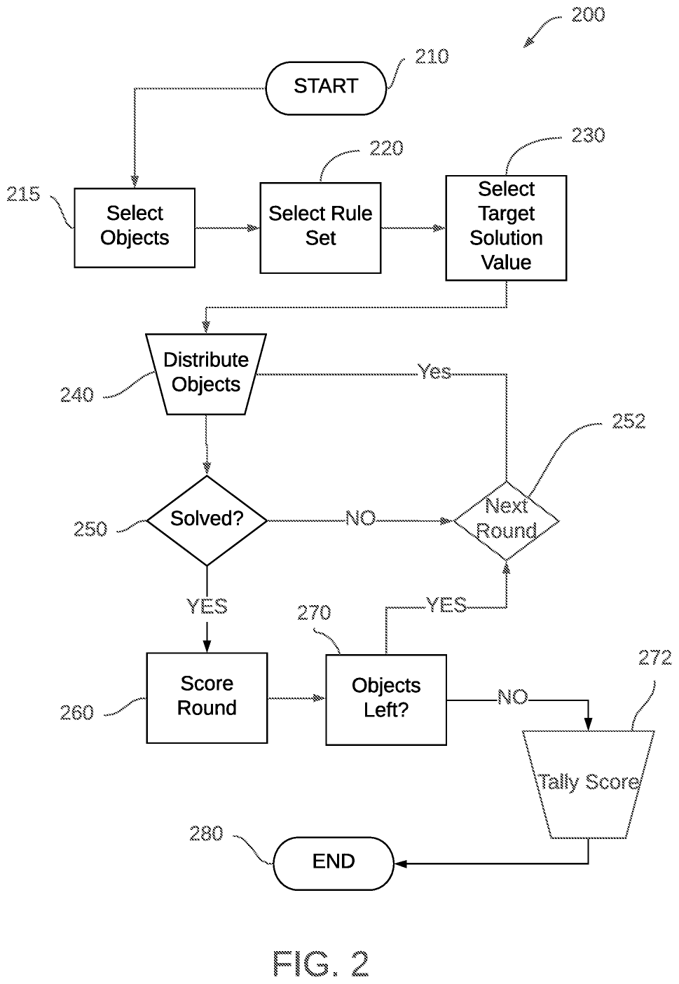

Referring now to FIG. 2, a flow chart of method 200 associated with an embodiment of activity 80 (FIG. 1), is shown. In this first embodiment, a collection of fifty objects 60 numbered one through ten is used as a resource for activity 80. According to method 200, at step 210, activity 80 is started and at step 215, one or more objects 60 are selected. At step 220, a rule set 30 is selected for activity 80. Next, at step 230, a target solution value 95 is selected. At step 240, four objects 60 are distributed for a simultaneous display to all students S. The rule set 30 associated with this first embodiment requires that each object 60 can only be used once, and, each object 60 must be used. For establishing value, objects 60 labeled with two through ten have the corresponding numerical value; objects 60 labeled with one can have the numerical value of either one or eleven.

In another version of activity 80, rather than distributing four objects 60 simultaneously, the teacher (or student lead) will distribute one object 60 at a time in sequence, providing a window of time for each student S to consider how the value of each object 60 might be used in developing a successful and winning mathematical expression 90.

In one aspect, student S may be challenged by activity 80 requiring elementary solutions. For example, using four objects 60, the student S will apply one or more mathematical operators 32 to create a mathematical expression 90 consisting of addition, subtraction, multiplication, and division to arrive at the targeted numerical solution value 95. In another aspect, student S is challenged by activities to present more advanced solutions leveraging the basic mathematical operators 32 and including one or more advanced mathematical expressions applied to the four objects 60 to arrive at a pre-selected target value.

Now, in additional detail, activity 80 proceeds according to the following steps. In step 240, four objects 60 are distributed with their numerical value showing to all other students S simultaneously. Each student S is then challenged in activity 80 to create a mathematical expression 90 using the four objects 60 to create a solution producing a numerical value result of twenty-one (“21”). As soon as student S believes they have identified a solution, in step 250, student S will indicate that they have “Solved” the problem. The first student S to call out “Solved” will present their mathematical expression 90 for confirmation of correctness. Where a student may not be able to speak, other means for providing an alert of “Solved” may be used. If correct, student S wins round 100. If incorrect, that student S no longer plays and the next student S who calls out “Solved” gets to present their solution. These steps repeat until a correct solution (a mathematical expression) is presented by a student S or all students S (and the teacher moderator) agree that a solution cannot be derived for the selected target solution value.

In one instance, one hundred objects 60 are used during activity 80, with four objects 60 distributed per round 100, supporting twenty-five rounds per activity 80. One point is awarded for each student S that provides a correct solution in a round 100. Student S winning the most rounds 100, and hence the most points, wins activity 80. If a round 100 is deemed unsolvable, no one wins a point for that round 100. Points may be awarded to the first student S that correctly asserts that the round is unsolvable.

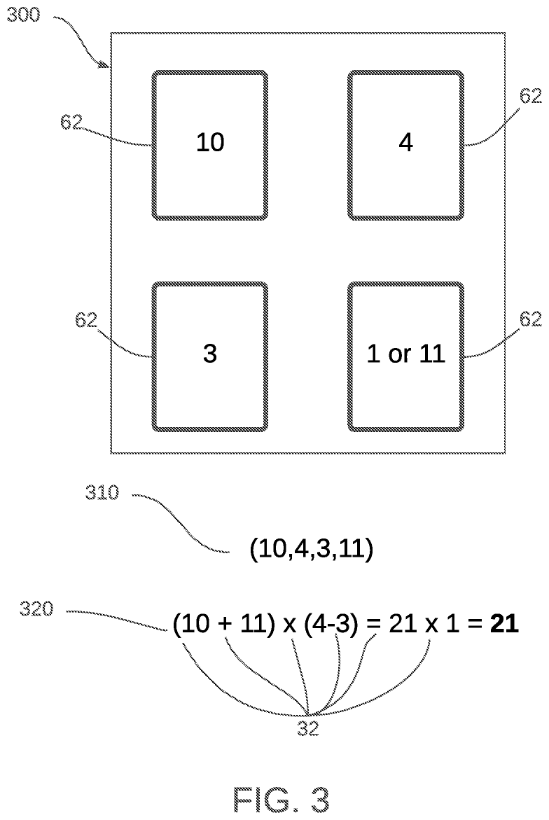

Referring now to FIG. 3 through FIG. 6, exemplary card combinations associated with a round 100 in activity 80 are illustrated. Referring to FIG. 3, in a first example, an object combination 300 is illustrated, revealing objects 60 having numerical values of ten, four, three, and either a one or eleven. Note that rule set 30 can prescribe that a one can have a numerical value of either one or eleven, and each student S may make their own determination as to the value of the object showing a face value of one for their specific solution. In this instance, student S has elected to use the value of eleven for the one, consequently, a first solution must be based on each object 62 accorded the following values: ten, four, three, and eleven, hereinafter represented as the grouping 310: (10, 4, 3, 11). In one instance, in solving for a target value of twenty-one, student S proposes a mathematical expression 320 based on combination 300 and grouping 310 as follows:

(10+11)×(4−3)=21×1=21

In this instance, all four objects 62 have been used, and, used only once in the mathematical expression 90, consistent with the current rule set 30.

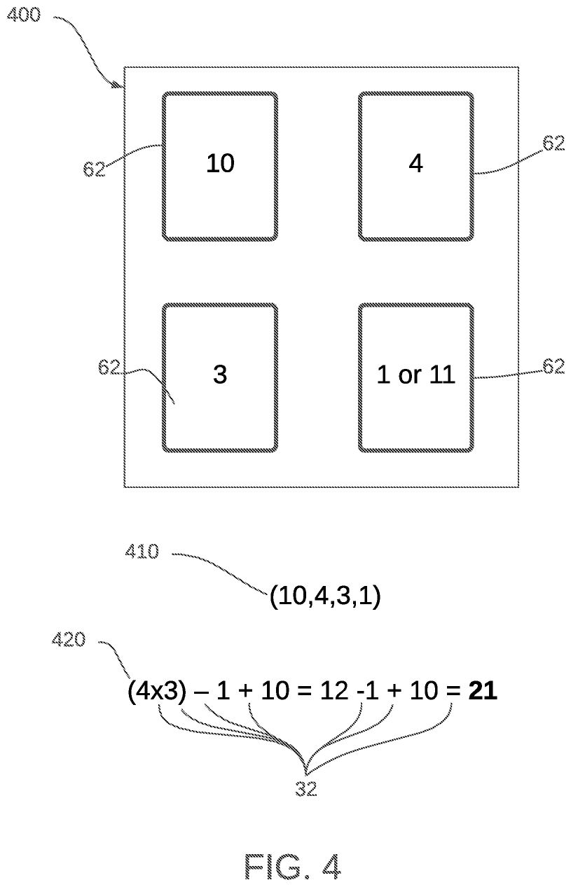

Referring now to FIG. 4, a second solution available to student S could include the following. In a card combination 400, three of the objects 62 are once again accorded the same values but the numeral, 1, is accorded a value of 1, creating a grouping 410 of (10, 4, 3, 1). Student S proposes the following mathematical expression 420, which solves for the solution value 95 of twenty-one, as follows:

(4×3)−1+10=12−1+10=11+10=21

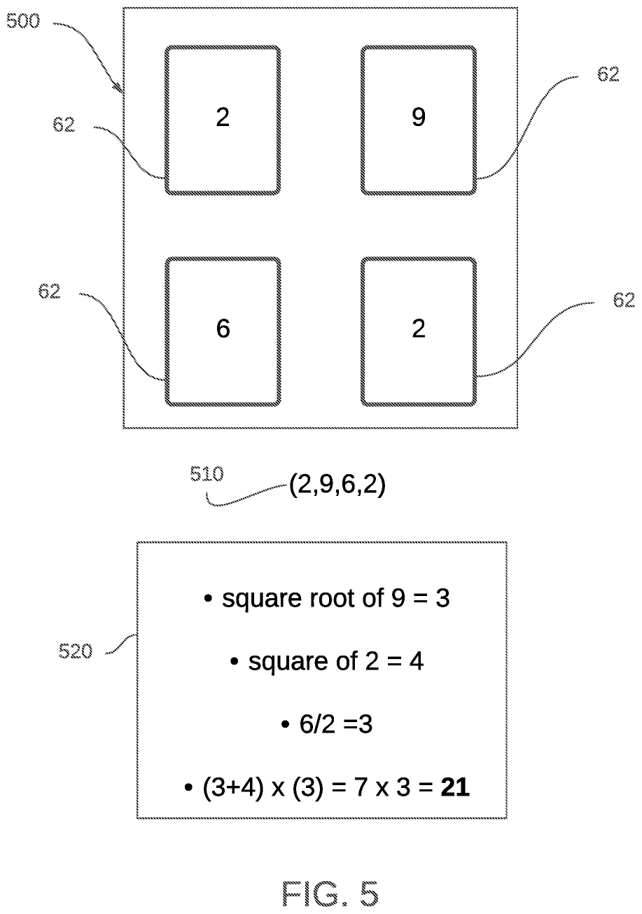

Referring now to FIG. 5, in a second more advanced example, four objects 62 are once again distributed with numerical values showing and exposed to all students S simultaneously. In this example, the card combination 500 establishes a grouping 510 of (2 9, 6, 2). A first solution is based on a mathematical expression 520 which uses squares and square roots, for example:

the square root of 9=3

square of 2=4

(3+2²)×(6/2)=(3+4)×(3)=7×3=21

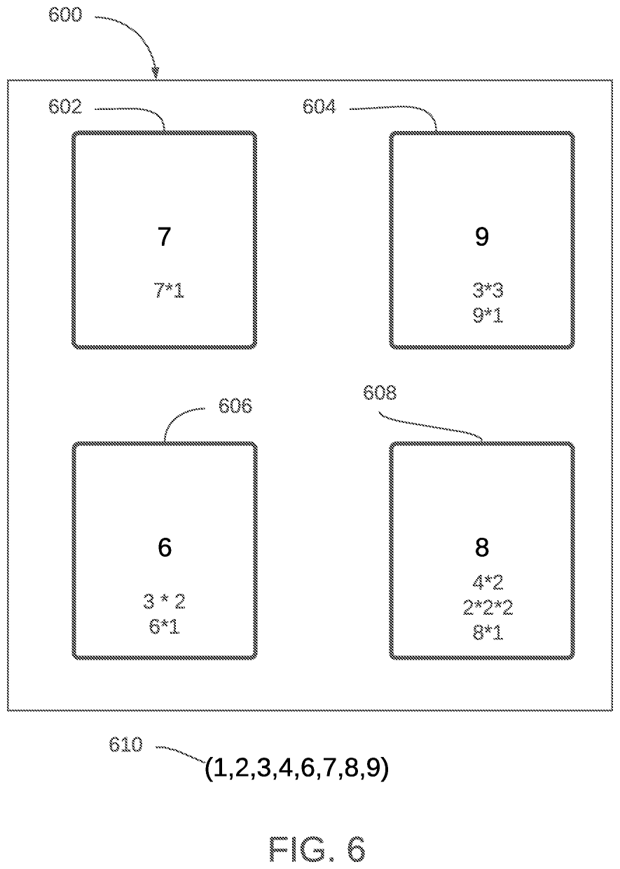

Referring now to FIG. 6, an alternative version of object 60 depictions is shown. Here, objects shown as cards 600 include information on each card 62 indicating factors of the number value on each card 62 wherein an alternative rule set 30 would allow each of the factors identified to be used in forming a mathematical expression 90 to arrive at a target solution value 95. For example, card 602 having a face value of 7 has only two factors: 7 and 1. Card 604 having a face value of 9 can be expressed via combinations of 3, 9, and 1. Card 606 having a face value of 6 can be expressed using, 3, 2, 1, and 6. Card 608 having a face value of 8 may be expressed using 8, 4, 2 and 1. Hence, a grouping 610 may comprise (1, 2, 3, 4, 6, 7, 8, 9). In addition, a rule set 30 may be adapted to use any number of the values in the grouping 610 for any number of times to arrive at a selected target value 95.

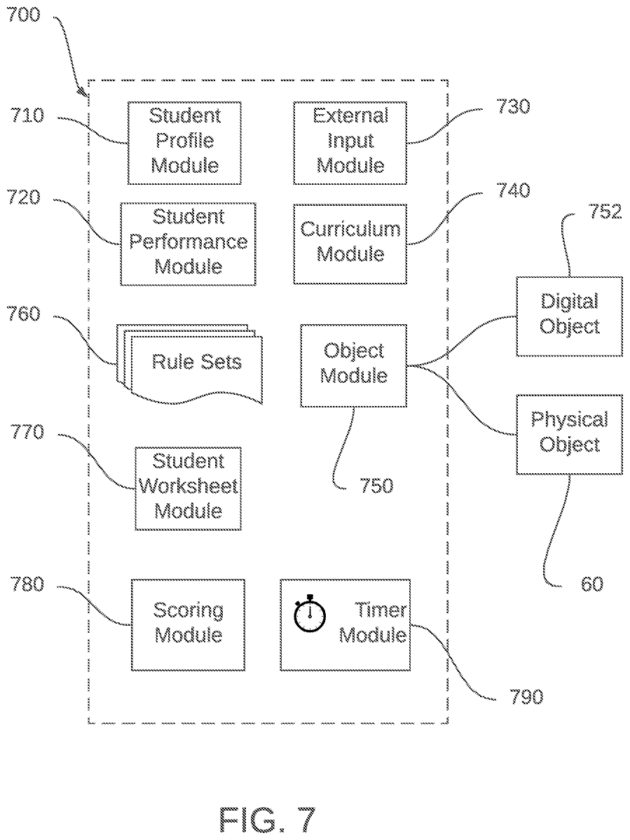

Referring now to FIG. 7, a block diagram comprising various modules of system 20 for use with one or more activities 80 deployed via a software application 700 is illustrated. A student profile module 710 aggregates and retains information concerning each student P. The student profile module 710 collects information from a student performance module 720, an external input module 730, and a curriculum module 740.

An object module 750 provides options to student S to select the use of either a digital object set 752 or a physical object set 60. In other versions, objects 60 comprising various numbers may be used. In still other versions, objects 60 having numbers, images, and mathematical operators 32 may be used.

For system 700, a rule sets module 760 provides a student S with options to select from one or more rule sets 30, which may also be identified by certain names, e.g., GOKIRO™ 822. A student worksheet module 770 provides a digital worksheet to be displayed to a student S to allow the student S to develop his or her proposed mathematical expression 90. A scoring module 780 tracks the winner of each round 100 and the ultimate winner of activity 80 after all objects 60 have been distributed during activity 80. A timer module 790 allows student S to set a time for the development of a mathematical expression 90 that can be solved for a solution value 95.

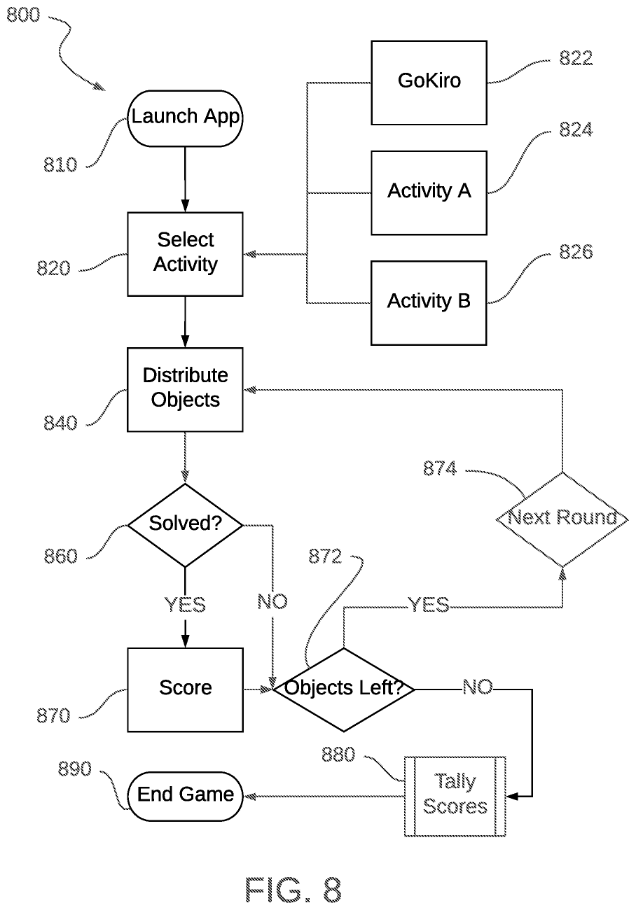

Referring now to FIG. 8, method 800 associated with the digital software application embodiment 700 of activity 80 is illustrated. At step 810, a student clicks on an appropriate icon on the user interface to launch the software application 700. At step 820, the student(s) S are provided with an option to select an activity 80 from a list of activities. As shown herein, the students may select any of GOKIRO™ 822, Activity A 824, or Activity B 826. Once the desired activity 80 has been selected in step 820, in step 840, application 700 will distribute the number of objects 62 as called for by the rule set 30 associated with the selected activity 80. The rule set 30 will also determine how the objects 62 are presented during activity 80. Each student S will then attempt to construct a mathematical expression 90, with each student S competing to generate a correct mathematical expression 90 before other students S, or, to beat the timer 70. In step 860, if the students S are unable to solve for an appropriate mathematical expression 90 using the combination of objects 60 in conjunction with various mathematical operators 32 according to the rule set 30 of the selected activity 80, then at step 872, the software application 700 will determine whether there are a sufficient number of objects 60 available to play an additional round 100. If “YES”, then the software application at step 840 will distribute additional objects 60 to play another round 100. If “NO”, then at step 880, the software application 700 will tally the scores of all students S and determine a winner. Once the winner is determined, at step 890, students S may end the activity.

If instead, a student S solves for the current targeted value using the distributed objects 62, that student S is awarded a score 870. The software application then checks to determine if enough objects 62 are left for another round 100. If so, the software application 700 causes the next round 874 to begin.

In another embodiment, the software application 700 is used by the students S to develop and manipulate their mathematical expression 90, while the objects 62 may be distributed from a physical object collection 60. In this hybrid embodiment, the values of an object 60 may be entered into the software application 700 by each student S or each student's device may be used to image an object 60 for ingestion into the application and presentation on each student's S display.

In another embodiment, the software application 700 processes an algorithm to randomly generate four objects 60 or numbers between one and ten for presentation to one or more students S. The value of a “1” may be either one or eleven. A user interface associated with the software application 700 allows a student S to drag and drop or draw the numbers and arithmetic symbols to formulate one or more mathematical expressions 90 along an expression line to test whether the outcome equals the target solution value 95. Once the appropriate mathematical expression 90 has been created such that the solution equals the target solution value, the software application 700 will notify student S that the mathematical expression 90 is correct and the solution has been “Solved”. Student S presses a button on a user interface indicating that the problem has been solved. In the event a student S is unable to arrive at a solution, student S may click a separate “Solver” button to allow the software 700 to either create and display one or more appropriate mathematical expressions 90 for consideration or, to notify the student S that there is no solution that will produce an outcome at the target solution value 95 from the objects 60 distributed in the current round 100.

In other embodiments, activity 80 may be structured to use any number of objects 60 and any solution value 95, besides “twenty-one”. As just one example, a rule set 30 may provide that six objects 60 are distributed and a target solution value 95 is “ninety-three”. In another instance, the software application 700 will allow student S to select both the number of objects 60 to use and, a target solution value 95.

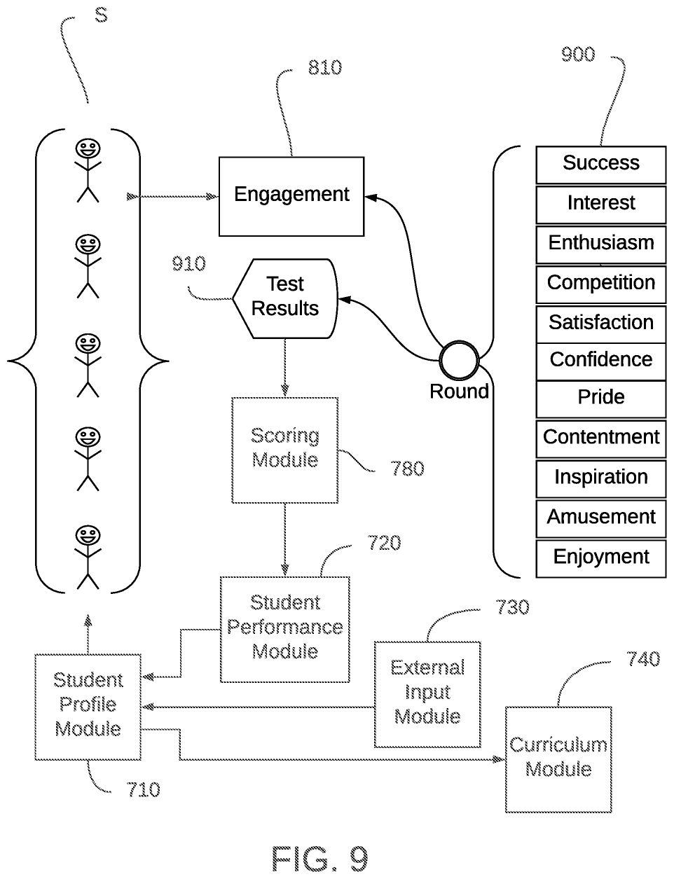

Referring now to FIG. 9, a diagram illustrating certain operations implemented via software application 700 associated with advanced features, outcomes, and benefits are shown. As shown, one or more students S may engage 810 in activity 80. As the students S participate in each round 100 of activity 80, they are likely to experience one or more feelings or emotions 900 due to the experience associated with engaging in activity 80. Other feelings and emotions 900 associated with the playing of an activity 80 may include enthusiasm, competition, satisfaction, confidence, pride, contentment, inspiration, amusement, and enjoyment. In greater detail, these feelings, and emotions 900 can be triggered during activity 80 by, for example:

a feeling of success when developing a solvable mathematical expression 90;

heightened interest as the rounds 100 proceed; a student S is likely to have his or her interest heightened by the opportunity to consider and play additional rounds 100;

the enthusiasm from participation in activity 80 with other students;

competitive drive associated with participation in an activity 80 with others;

satisfaction, particularly when arriving at a correct solution during an activity 80;

confidence as student S progresses through multiple activities and recognizes that his or her skills are improving;

Murray Tech Law

pride as a participant in activity 80 and when identifying correct solutions;

contentment from participation in activity 80 and the opportunity to socially engage with other students S;

inspiration from success in the activity 80 or near-success;

amusement from the participation of other students S and the potential for camaraderie in association with the activity 80; and,

enjoyment, simply by participating in activity 80 with others.

Once each round 100 is completed, the results 910 for one or more students S are aggregated by the scoring module 780. The scoring module 780 will then transmit results to the student performance module 720 for each student S. The student performance module 720 processes the data from the scoring module 780 and transmits the results to the student profile module 710 for the particular student S. In addition to the performance information, the student profile module 710 collects and stores additional external information from an external input module 730. The external input module 730 provides an interface for parents, teachers, and students S to contribute additional information to the relevant student profile module 710. As the student profile module 710 continues to develop and aggregate both performance and external input, the student profile may be sent to curriculum module 740. The curriculum module 740 processes the data from the student profile module 710 and provides suggestions and recommendations for the appropriate curriculum level for each student S.

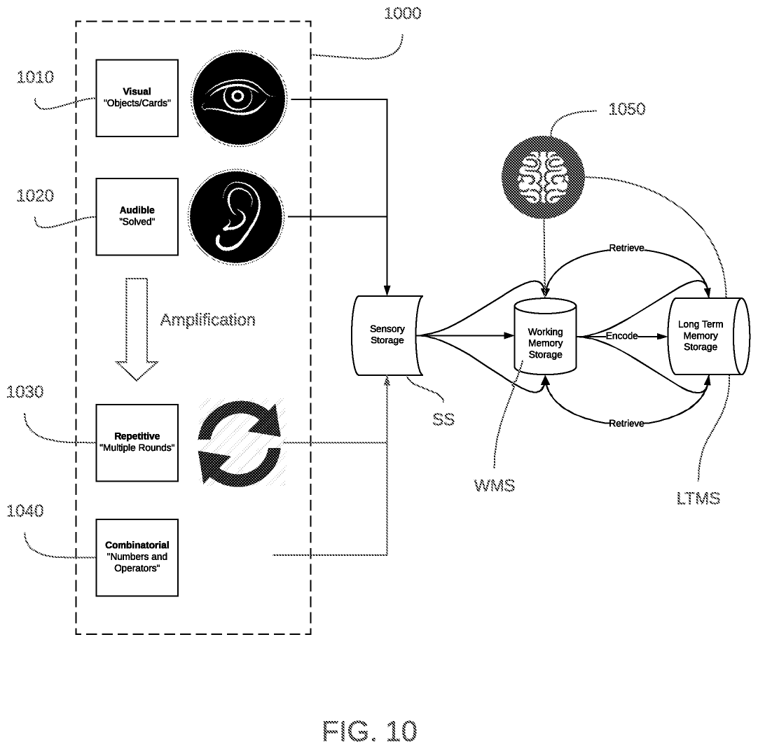

Referring now to FIG. 10, a diagram illustrating key sensory and cognitive features 1000 leveraged in association with the inventive subject matter is shown. The key features 1000 include sensory inputs, e.g., visual 1010, audible 1020; repetition 1030 for retention; and combinatorial processing 1040 to create a novel approach to mathematical cognitive enhancement. Each of these features 1000 contributes to the retention of mathematical skill sets and knowledge by each student S during each round 100. Visual 1010 and audible 1020 features are further amplified and reinforced through repetitive features 1030 and the use of a combinatorial approach 1040 based on numbers and operators. Each of the features 1000 contributes to the experience associated with engaging in an activity 80 and effective ingestion into a student's sensory storage in the student's brain 1050. The structure of each activity 80 comprised of succinct and short rounds 100, with repetition through the use of object sets 60, creates an enhanced retention of the mathematical skills and knowledge. By playing activity 80 repetitively, the mathematical know-how becomes reinforced in the student's working memory storage (“WMS”) and the student's long-term memory storage (“LTMS”).

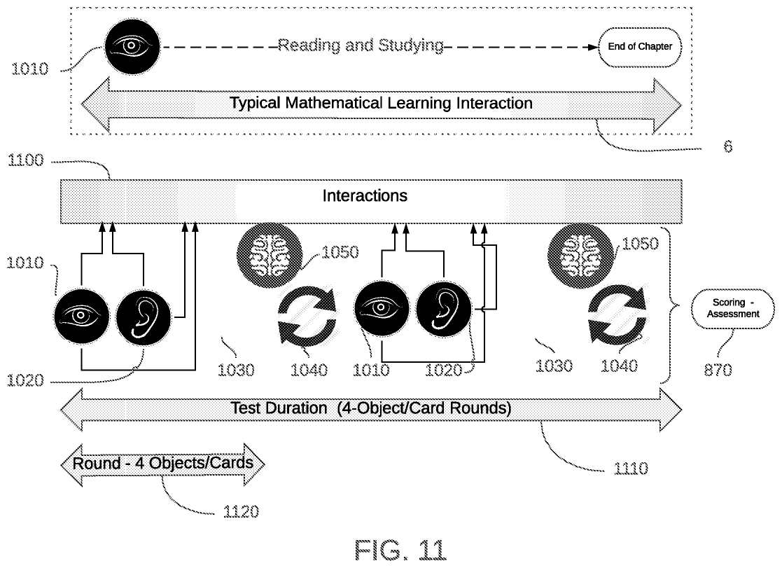

Referring now to FIG. 11, the sensory interaction of student S with a typical mathematical learning interaction 6 (associated with reading, studying, and performing homework to develop math skills) is shown. In addition, the sensory interactions 1100 associated with engaging in activity 80 according to the inventive subject matter is illustrated. As shown in FIG. 11, the primary interaction for a typical mathematical learning interaction 6 is via visual input 1010.

The interactions associated with the inventive subject matter include sensory inputs that can be visual 1010, audible 1020, and tactile 1100. The implementation of repetition 1030 and combinatorial approaches 1040 cause the interaction and the associated mathematical knowledge and skills associated with engagement in activity 80 to be continually reinforced in a student S's brain 1050, including long-term memory storage LTMS. For example, in one instance, activity 80 comprises twenty-five rounds 100 of four objects 62 (FIG. 3) per round 1120. The implementation of an activity duration 1110 based on one hundred objects 60 is intended to create a targeted, enjoyable learning experience to improve retention by student S of the associated mathematical proficiency and logical skills.

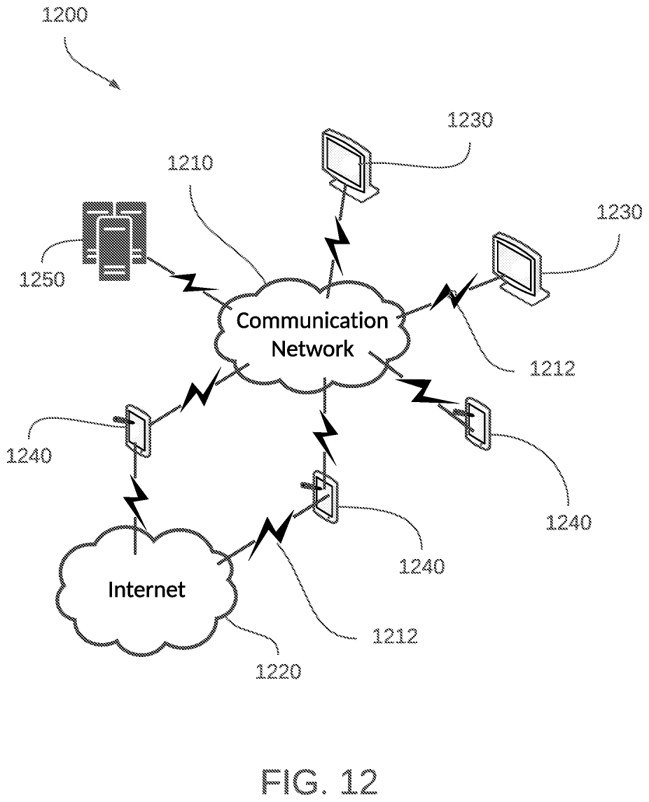

Now referring to FIG. 12, wherein a software application 700 is used for engaging in each activity 80, the system 20 and method 800 may be implemented in a digital processing environment 1200 across a global communication network 1210, supported by the Internet 1220 and the World Wide Web. FIG. 12 is an exemplary illustration of a computer network or similar digital processing environment 1200 in which system 20 and method 800 according to the inventive subject matter may be implemented. Client computer(s)/devices 1240, the server computer(s) 1230, and clustered computers 1250 provide processing, storage, and input/output devices executing application programs and the like. Client computer(s)/devices 1240 can also be linked through the communications network 1210 to other computing devices, including other client devices/processes 1240, server computer(s) 1230, and clustered computer servers 1250.

Communications network 1210 can be part of a remote access network, a global network (e.g., the Internet 1220), a worldwide collection of computers, Local area or Wide area networks, and gateways that currently use respective protocols (TCP/IP, Bluetooth, etc.) to communicate with one another. Other electronic devices/computer network architectures are suitable.

Furthermore, embodiments of the inventive subject matter can take the form of a computer program product accessible from a computer-usable or computer-readable medium providing program code for use by or in connection with a computer or any instruction execution system. For this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, random-access memory (RAM), read-only memory (ROM), a rigid magnetic disk, and an optical disk. Some examples of optical disks include compact disc-read-only memory (CD-ROM), compact disc read/write (CD-RW), and DVD.

A data processing system suitable for storing and/or executing program code will include at least one processor 1310 coupled directly or indirectly to memory elements 1320 through a system bus. The memory elements 1320 can include local memory 1330 employed during the actual execution of the program code, bulk storage, and cache memories, which provide temporary storage of at least some program code to reduce the number of times code is retrieved from bulk storage during execution.

Input/output 1340, 1350, or I/O devices (including but not limited to keyboards, displays, pointing devices, touch screens, gesture recognition interfaces, smartphones, kiosks, RFID identifiers, smart cards, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

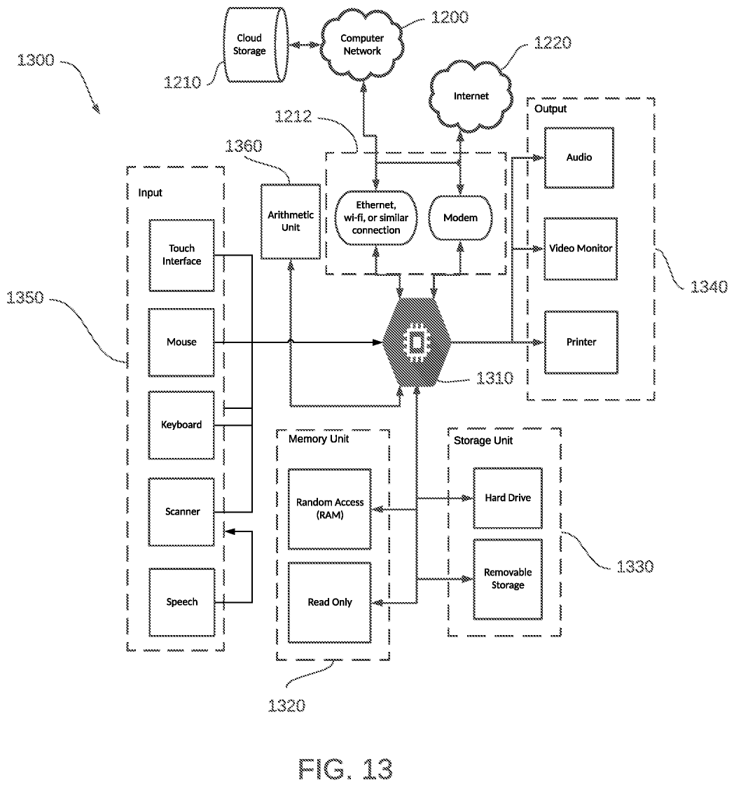

Referring in greater detail to FIG. 13, a detailed description of an illustrative computational node 1300 associated with the implementation of system 20 and method 800 according to the inventive subject matter is provided. The computational node 1300 may be a tablet, mobile phone, laptop computer, desktop computer, or gaining console. The computational node 1300 may take multiple forms of input 1350, including but not limited to touch input, mouse input, keyboard, scanner, audio (such as voice input), and other types of sensors, e.g., hardware beacons or other presence sensors. Output modes 1340 include audio output and visual output, which may include output to both a video monitor for display to a student S and a printer to print content as desired for perusal by the student S. The computational node 1300 includes one or more central processing units (CPU) 1310 with an arithmetic unit 1360 for processing instructions associated with the software of the system 10. Note that the computational node 1300 may likewise include one or more graphical processing units (GPU). The computational node 1300 also includes a memory unit 1320 comprised of random-access memory (RAM) and read-only memory (ROM). System 10 has flexibility and scalability to address rapid growth since data storage may be provided by a storage unit 1330, which may be any of a hard drive or removable storage. A hard drive used for storage may be local or remote or on a cloud storage device 1210 or network-attached storage device. Data storage units 1330 serve as digital repositories for one or more information resources associated with the inventive subject matter

Computational node 1300 includes a communication modality 1212 for network access via, for example, either Ethernet, Wi-Fi, cellular, or other similar data transport mediums. Computational node 1300 may communicate with public and private computer network 1200, including the Internet 1220, providing access to additional networked computer resources and cloud storage

Thus, specific compositions and methods of the computer-implemented system 20 and method 200 and method 800 to enhance cognitive retention of digital transactions have been disclosed. It should be apparent, however, to those skilled in the art that many more modifications besides those already described are possible without departing from the inventive concepts herein. The inventive subject matter, therefore, is not to be restricted except in the spirit of the disclosure.

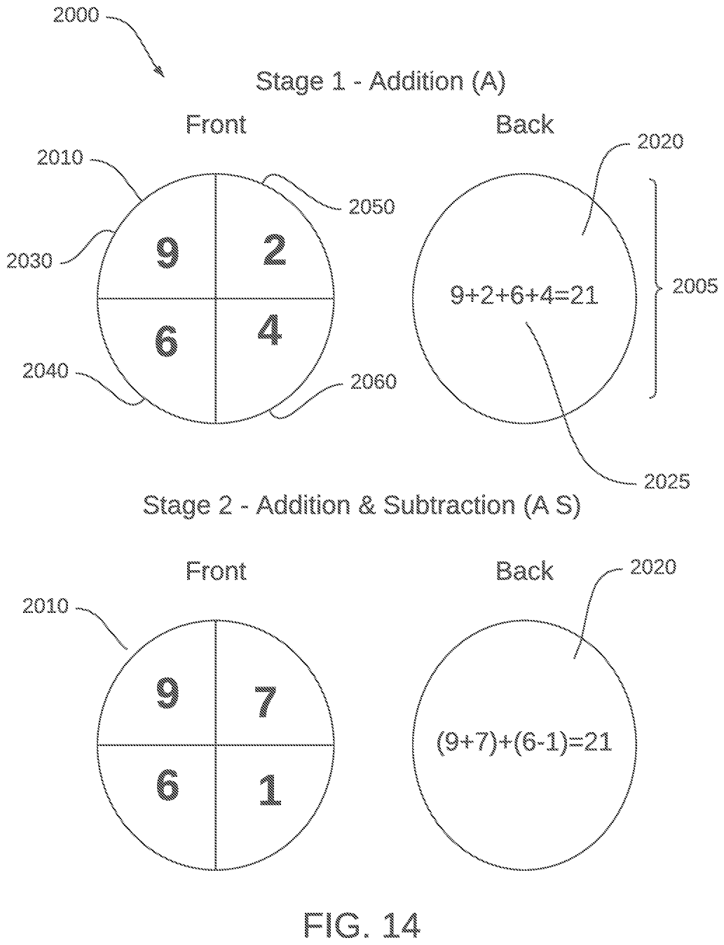

For example, in an alternative embodiment illustrated in FIG. 14, a version of the activity may be designed for various educational and aptitude levels. FIG. 14 illustrates a progressive implementation of the GOKIRO™ system 2000 using a unique circular card configuration 2005 having a front side 2010 and a backside 2020. On the front side 2010, each card 2005 is separated into four quadrants 2030, 2040, 2050, 2060, wherein each quadrant 2030, 2040, 2050, 2060 includes a number one through ten. Here, a single card dealt to a student S will have four numbers displayed on the front side 2010 of the card. On the back side 2020 of the card, one or more solutions 2025 will be shown. The cards 2005 will range in difficulty, for example, by first starting with Addition only, then Addition & Subtraction, Addition-Subtraction-Multiplication, Addition-Subtraction-Multiplication-Division, and lastly all possible math expressions Addition-Subtraction-Multiplication-Power-Roots-Factorial. As shown, in Stage One, student S is confronted with using only addition to arrive at the desired solution value. In Stage Two, student S is required to use both addition and subtraction to arrive at the desired solution value, in this case, twenty-one. In addition, the cards may be of a unique shape, e.g., oval, circular, hexagonal, etc. which allows interesting means for distribution to the students S. For example, the oval cards shown in FIG. 14 may be dealt to participants in a spinning motion, similar to a Frisbee, causing each participant to watch the numbers on the card as it is spinning, creating more excitement and anticipation during the progress of the game.

Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced.

While numerous aspects and embodiments of the inventive subject matter have been particularly shown and described with references to specific elements or features thereof, it will be understood by those skilled in the art that various changes in form and details may be made therein without departing from the scope of the inventive subject matter encompassed by the appended claims.

As contemplated herein, various aspects and embodiments of the inventive subject matter can take the form of an entirely hardware embodiment, an entire software embodiment, or an embodiment containing both hardware and software elements. In one embodiment, the inventive subject matter is implemented in software, which includes but is not limited to firmware, resident software, microcode, and other forms.

What is claimed is:

1. A computer-implemented system for augmenting cognitive retention of students via mathematical activities, comprising:
a. a computing device configured to manipulate object presented for use in relation to said mathematical activities; a digital network for communication between two or more students;
b. an activities software module operable on said computing device, said activities software module orchestrating competitive play for said two or more students;
c. a digital repository associated with said computer-implemented
d. system for storing software and associated logical instructions associated with one or more activities; wherein said one or more activities are played using an object set;
e. wherein said object set may be used to distribute said objects during a
f. round;
g. during each round, one or more students attempt combining said each set of objects with one or more mathematical operators to arrive at a mathematical expression that solves to a desired solution value; and
h. each of the one or more students compete to solve for said desired solution value.

2. The system of claim 1 further comprising:
a. one or more rule sets;
b. student worksheets;
c. score sheets; and,
d. a timer,
e. said one or more rule sets describing guidelines to be adhered to during an activity;
f. said worksheets usable by each student to write down one or more mathematical expressions based on said objects to arrive at a mathematical expression that solves to said desired solution value;
g. said score sheets used to track rounds won by each student;
h. said timer used to set a time limit for each round of play for students to announce a proposed mathematical expression.

3. The system of claim 2 wherein a student verbally announces a mathematical expression rather than writing down a mathematical expression on a score sheet.

4. The system of claim 1 wherein said solution value is the numerical value of twenty-one.

5. The system of claim 1 further comprising an input management and tracking system, said input management and tracking system acquiring data concerning a student's performance in association with said activities to identify areas for improvement to render an appropriate learning and curriculum roadmap.

6. The system of claim 1 further comprising a student profile wherein the system provides recommendations for said curriculum roadmap and said student profile supplemented by input from teachers, parents and students.

7. The system of claim 6 wherein supplementation to said student profile may be subjective based on teacher and parent input and objective based upon other assessments of a student's capabilities.

8. The system of claim 7 wherein one or more algorithms are applied to process data associated with student performance along with the inclusion of subjective and objective inputs to create aggregate information used to determine which activities should be presented to a student to advance the student's mathematical cognitive development.

9. A method for augmenting cognitive retention and enhancing mathematical skills, comprising:
a. presenting numerical objects in multiple rounds for display to one or more students;
b. during each round, each student attempting combine each of said numerical objects with one or more mathematical operators creating a mathematical expression that may be solved to arrive at a a desired solution value before another student;
c. determining a winner of a round, wherein a first student to create and present a correct mathematical expression arriving at said desired solution value is determined the winner of the round;
d. continuing steps a through step c for a specified number of additional rounds; and,
e. after completion of said specified number of rounds, totaling the number of rounds won by each student, wherein the student with the highest number of rounds won is designated the winner of the activity.

10. The method of claim 9 wherein said solution value is the numerical value of twenty-one (“21”).

11. The method of claim 9 wherein said solution value is any integer.

12. A system for enhancing a student's mathematical skills comprising:
a. one or more cards having four numbers listed on a front side of each card presented to one or more students;
b. a designated target solution value identified to said one or more students;
c. a back side of each card listing one or more mathematical expressions which solve for the designated target solution value.

13. The system of claim 12 wherein said one or more cards have a circular shape, an oval shape, a triangular shape, a square shape, a pentagonal shape, a hexagonal shape, and an octagonal shape.

14. The system of claim 13 wherein said one or more cards are dealt to said one or more students in a spinning motion.
